(19) United States
(12) Patent Application Publication
(10) Pub. No.: US 2007/0274754 A1
(43) Pub. Date: Nov. 29, 2007

(54) Printer

(76) Inventors: Yasuhiro Tanaka, Wakayama-shi (JP); Yoshihisa Sugata, Osaka (JP); Hisashi Omori, Wakayama-shi (JP)

Correspondence Address: FULBRIGHT & JAWORSKI, LLP, 666 FIFTH AVE, NEW YORK, NY, 10103-3198, US

(21) Appl. No.: 11/804,106

(22) Filed: May 17, 2007

(30) Foreign Application Priority Data
May 23, 2006 (JP) 2006-142799

(51) Int. Cl. B41J 2/315

(52) U.S. Cl. 400/120.03

(57) ABSTRACT

A printer forms an image on a print sheet drawn from a print sheet roll, with using a print head. A transport roller unit for drawing the print sheet from the roll and transporting it to the print head includes a drive roller for taking up the print sheet around a peripheral surface thereof for a predetermined distance in a transporting direction, with the printing face thereof being on the inner side, thus applying a transporting force thereto and an opposing portion for causing the print sheet into abutment against the peripheral surface of the drive roller.

### RELATED APPLICATION

This application claims priority from Japanese Patent Application No. 2006-142799 filed May 23, 2006, incorporated by reference in its entirety.

### BACKGROUND OF THE INVENTION

1. Field of the Invention

The present invention relates to a printer for forming an image on a print sheet transported thereto, by a print head.

2. Description of the Related Art

As an example of a printer of the above-noted type, there is known a printing apparatus in which a print head forms an image by jetting ink onto a print paper drawn out of a magazine housing which accommodates a print paper roll (a print sheet) therein and then the image-printed print paper is transported to a cutter unit to be cut into a print size paper strip to be discharged as a photographic print (see. e.g. Japanese Patent Application “Kokai” No. 2005-199551, paragraphs 0029-0032, FIG. 4). In this printing apparatus, the print paper drawn out of the magazine housing by damping type feed rollers is wound about a clamping type print transport roller to be changed in its direction substantially perpendicularly before being fed to the area of the print head. More particularly, the print paper is wound about the peripheral surface of the print transport roller, with forming a center angle of 110 degrees approximately and with a printing face of the sheet being on the outer side. This construction is not particularly problematic as long as a standard inkjet printing paper sheet is employed as the print paper. This can be problematic, however, in the case of a high quality printing sheet. Namely, such quality print paper sheet consists of a base and a printing layer formed thereon, the printing layer being very “sensitive” (meaning vulnerable to a fissure when subjected to a tensile force) for forming high-precision photographic image thereon. In this case, a tensile force will be applied to the printing face which is the outer face of the print paper wound about the peripheral surface of the print transport roller, thus leading to development of fine fissure in the printing layer, which is a significant problem for the print quality.

Further, there is also known an ink jet printer in which from a roll of a highly rigid recording medium (print sheet) wound with its printing face on the outer side, the recording medium is drawn and pinched and transported by a drawing drive roller and a pressing roller to be fed to an ink head, in the course of which there is provided an angle portion for changing direction of the recording medium paper while bending the printing face thereof to be oriented to the inner side, so that the recording medium will reach the ink head after having its curling tendency eliminated by the angle portion (e.g. Japanese Patent Application “Kokai” No. 2003-221151, paragraphs 0013-0022, FIGS. 1 and 2). In the case of this ink jet printer, at the angle portion, the recording medium assumes a curved shape with its printing face being on the inner side. Therefore, even when the above-described print sheet having a very sensitive printing layer formed on the base is employed as the recording medium, the problem of development of fissure in the printing layer due to application of a tensile force at the angle portion is avoided. However, the feeding operation of the printing medium to the ink head, that is, an auxiliary scanning transport operation for image forming by the ink head, is effected by a drive roller and a press roller which are disposed on the upstream of the angle portion. Then, the angle portion disposed in the mid of this route can be a load factor for this auxiliary scanning transport operation, which makes precision positioning transport of the medium required for high quality image formation difficult.

In view of the above-described state of the art, an object of the present invention is to provide a printer which can avoid damage to the printing face of the print sheet due to a tensile force generated at a turning area (course-changing area) provided in a transport line extending to the print head even when a print sheet having a sensitive printing layer on the base is employed and which also can avoid any interference in the transport of the sheet at the turning area.

### SUMMARY OF THE INVENTION

In accordance with an embodiment of the present invention, a printer with an image forming print head comprises a roll holder and a transport roller unit. The roll holder holds a roll of print sheet wound with a printing face thereof being on the outer side. The transport roller unit feeds the print sheet drawn out of the roll holder to the print head. The transport roller unit comprises a drive roller for taking up the print sheet around a peripheral surface thereof for a predetermined distance in a transporting direction, with the printing face thereof being on the inner side, thus applying a transporting force thereto, and an opposing portion for causing the print sheet into abutment against the peripheral surface of the drive roller.

In accordance with an embodiment of the present invention, a printer with an image forming print head comprises a roll holder and a transport roller unit. The roll holder holds a roll of print sheet wound with a printing face thereof being on the inner side. The transport roller unit feeds the print sheet drawn out of the roll holder to the print head. The transport roller unit comprises a drive roller for taking up the print sheet around a peripheral surface thereof for a predetermined distance in a transporting direction, with the printing face thereof being on the inner side, thus applying a transporting force thereto, and an opposing portion for causing the print sheet into abutment against the peripheral surface of the drive roller.

Namely, in the case of either the first type of printer configured to form an image, with using a print head, on a print sheet drawn out of a print sheet roll wound with its printing face being on the outer side or the second type of printer configured to form an image, with using a print head, on a print sheet drawn out of a print sheet roll wound with its printing face being on the inner side, the present invention provides a drive roller for taking up the print sheet around a peripheral surface thereof for a predetermined distance in a transporting direction, with the printing face thereof being on the inner side, thus applying a transporting force thereto and an opposing portion for causing the print sheet into abutment against the peripheral surface of the drive roller.

With the above construction, regardless of the inner or outer side orientation of the printing face of the print sheet set in the print sheet roll, the print sheet drawn out of the print sheet roll is wound about the drive roller of the transport roller unit with the printing face of the sheet being on the inner side and clamped between this drive roller and the opposing portion to receive a strong and reliable transporting force. And, even if the direction of the print sheet is changed as being wound about the drive roller with a sufficient winding angle, no tensile force will be applied to the printing face of the print sheet, since this printing sheet is disposed on the inner side of the curved print sheet. Consequently, it is possible to avoid damage in the printing layer due to formation of fissure therein due to application of a tensile force. Moreover, as the direction changing face for directing the print sheet toward the print head is provided by the peripheral surface of the drive roller per se, this direction change does not cause reduction in the transporting force, so that the transport roller unit can apply an even stronger and more reliable transporting force to the print sheet as being wound about the drive roller.

Further, in order to achieve both the ability to apply an appropriate transporting force to the print sheet and non-application of excessive bending load in the Course of this transporting force application, it is preferred that the print sheet be wound about the drive roller with a winding angle of about 90 degrees. To this end, according to an embodiment of the present invention, a first print sheet portion extending from the roller holder to the drive roller is substantially normal to a second print sheet portion extending from the drive roller to the print head. With this, even when the print sheet is changed in direction with a substantially right winding angle by the drive roller, as the printing face is located on the inner side of the print sheet, no tensile force will be applied thereto, thus avoiding the damage of development of fissure in the printing layer due to application of the tensile force.

Further, for stabilization in the posture of print sheet drawn out of the holder by means of gravity and for stabilization of the print sheet during image formation by the print head, according to an embodiment of the present invention, said roller holder is located vertically upward of said drive roller and said drive roller and said print head are located in a substantially same level in the horizontal direction.

Regarding the opposing portion which applies an even stronger transporting force to the print sheet in cooperation with the drive roller, it is preferred that this opposing portion be comprised of a clamping roller, if possibility of damage to the print sheet due to friction is to be considered. More preferably, the opposing portion is comprised of a pair of clamping rollers spaced apart from each other in the print sheet transporting direction and disposed in opposition to the peripheral surface of the drive roller. This construction is advantageous in that it allows precise direction change of the print sheet by way of a center angle formed between the two clamping rollers.

The printer used for Outputting photographic prints usually employ a line printing type print head for forming high quality images, and the image resolution of this printer in the main scanning direction is determined by the precision of the print head. Whereas, for the image resolution in the auxiliary scanning direction, the positional precision of the print sheet to be fed to the print head is important. In this respect, the transport roller unit configured to feed the print sheet while the sheet being wound about the roller is capable of feeding the print sheet with high precision. Therefore, it is advantageous for the positioning of the print sheet in the auxiliary scanning direction to be effected by this transport roller unit. Incidentally, the “line printing type” refers to a construction wherein images for one or more lines are formed one after another in association reciprocal movement along the main scanning direction or a construction wherein images for one or more lines are formed one after another without any movement in the main scanning direction, with using a print head elongate in the main scanning direction.

When the print sheet is fed to the print head by the transport roller unit and the print head is to form an image on this print sheet, it is important that this print sheet is kept tense and flat. To this end, according to one preferred embodiment of the present invention, in order to apply a tension to the print sheet passing the print head, on the downstream side of the print head in the print sheet transporting direction, there is provided an assist transport roller unit having a higher peripheral speed, but providing a smaller transporting force for the print sheet, than the transport roller unit. With this, although the assist transport roller unit tends to pull and transport the print sheet passing the print head, as this print sheet is governed by the transporting force (clamping force) of the transport roller unit, it is possible to tense this print sheet flat while allowing slight slippage thereof.

Further and other features and advantages of the present invention will become apparent upon reading the following detailed description of the preferred embodiments thereof with reference to the accompanying drawings.

### BRIEF DESCRIPTION OF THE DRAWINGS

FIG. 1 is a schematic diagram showing a printer according in accordance with an embodiment of the present invention;

FIG. 2 is a section view showing an example of an ink jet paper for use in the printer shown in FIG. 1;

FIG. 3 is a perspective view slowing layout of various members and components around a print head; and

FIG. 4 is a schematic diagram showing a printer in accordance with an embodiment of the present invention.

### DESCRIPTION OF THE EMBODIMENTS OF THE PRESENT INVENTION

Next, various embodiments of the present invention will be described with reference to the accompanying drawings. FIG. I is a schematic diagram showing an embodiment in which a printer technique of the present invention is applied to an ink jet printer.

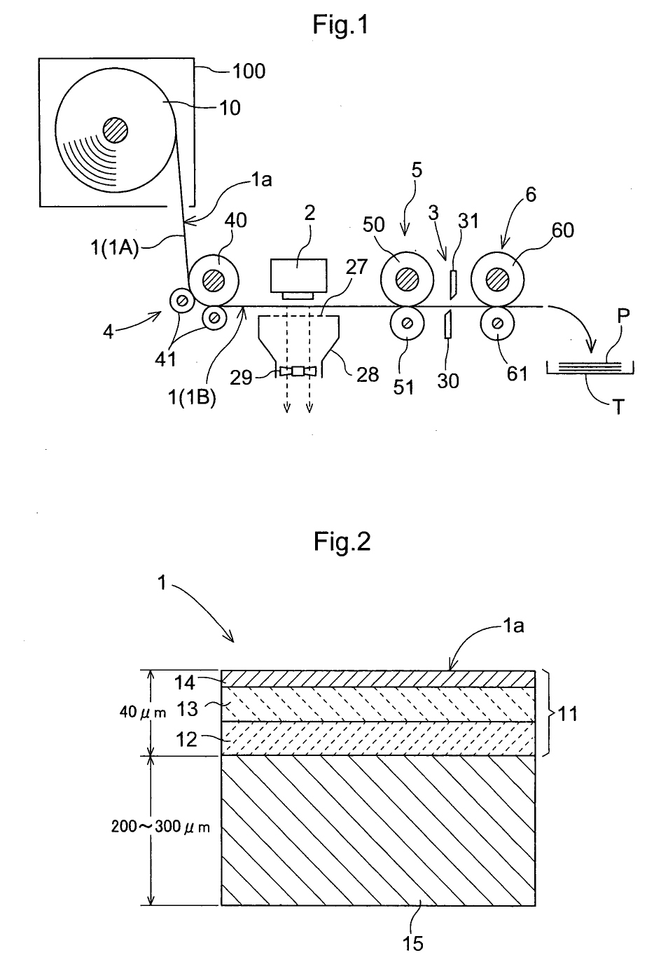

As shown in FIG. 1, according to this ink jet printer in operation, a length of ink jet paper 1 for production of photographic print P is drawn out from a roll (print sheet roll) 10 comprised of a rolled elongate ink jet paper having a printing face 1a suitable for photographic printing on its front face (printing face) and a print head 2 jets ink onto this paper 1 thus forming an image thereon; thereafter, the image-formed portion of the ink jet paper 1 is cut by a cutter unit 3 and then discharged as a photographic print P onto a tray T. The roll 10 is rotatably held within a roll holder 100 disposed upward to be drawn out of this holder.

This ink jet printer 1, as may be apparent from the section view shown in FIG. 2, consists of a substrate (base) 15 formed of a polyethylene-coated paper and a printing face area 11 with an outermost surface thereof acting as the printing face. The printing face area 11 includes a gloss layer 14, an ink absorbing layer 13 and a whiteness providing layer 12 in this order from the outer surface side thereof. This printing layer as a whole has thickness of only 40 μm, as compared with 200 μm to 300 μm thickness of the substrate 15. For this reason, if this ink jet paper 1 is bent or curved with its substrate 15 being on the inner side, a significant tensile force will be applied to the printing face area 11, in particular, to the printing face 1a. The ink absorbing layer 13 is particularly vulnerable to development of fissure therein due to application of a tensile force, since in this layer, super fine particles, binder or the like are distributed with much sparseness therebetween. On the other hand, this ink absorbing layer 13 has a fairly high strength against a compression force, in comparison with tensile force. In this embodiment, the roll 10 is formed by winding the elongate ink jet paper 1 with its printing face 1a on the upper side (outer side), and a roll core of a relatively large diameter not to cause tensile damage in the ink absorbing layer 13 is employed for this roll 10.

The print head 2 is a line printing type head, such that this head 2 is movable back and forth in a direction transverse to the longitudinal direction (transporting direction) of the ink jet paper 1. The print head 2 is supplied with inks under a pneumatic control via sub tanks from seven replaceable ink cartridges holding therein inks of e.g. black (BK), light black (LK), cyan (C), magenta (M), light cyan (LC), light magenta (LM), and yellow (Y), respectively.

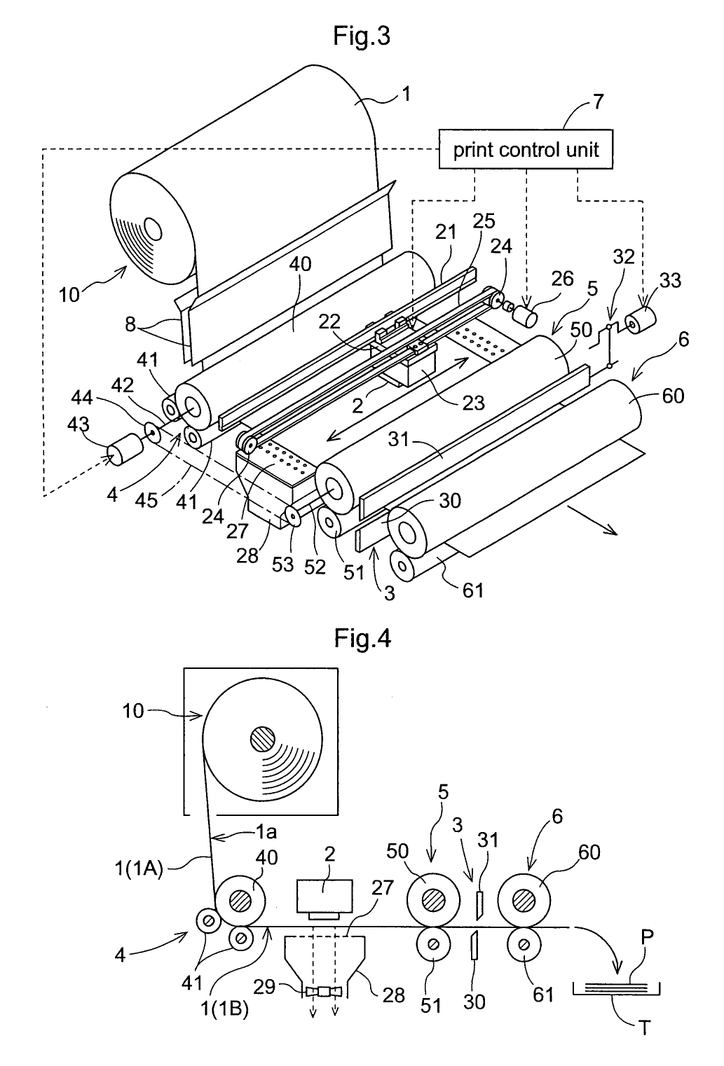

For moving the print head 2 back and forth along the main scanning direction, as shown in FIG. 3, a carriage 23 is mounted on a slider 22 which is guided by a guide rail 21 disposed along the main scanning direction and the print head 2 is attached to the lower face of this carriage 23. Adjacent opposed terminal ends of the guide rail 21, there are disposed a pair of pulleys 24, around which a timing type drive belt 25 is entrained. And, a main scanning motor 26 is also provided for driving one pulley 24. As the carriage 23 is fixed at a predetermined portion of this drive belt 25, in association with forward/reverse rotations of the pulleys 24 by forward/reverse driving of the main scanning motor 26, the print head 2 is moved back and forth (main scanning movement) together with the carriage 23.

As shown schematically in FIG. 1, on the opposite side to the print head 2 across the transport line of the ink jet paper 1, there is disposed a guide plate 27 which comes into contact with the back face (the substrate 15 side) of the ink jet paper 1 for guiding it. Downwardly of this guide plate 27, there are provided a negative pressure box 28 forming a negative pressure chamber for applying a negative pressure to the ink jet paper 1 through a number of through holes defined in the guide plate 27, thereby restricting floating displacement of the paper 1, and a fan 29 for generating the negative pressure by discharging air inside the negative pressure box 28 to the outside.

At an intermediate position on the sheet transporting line extending from the roll 10 to the print head 2, there is provided a transport roller unit 4 operable to draw a length of the ink jet paper 1 from the roll 10 and feeding it to the print head 2. In this particular embodiment, as the roll 10 is disposed upwardly of the print head 2, this sheet transporting line consists of a vertical transporting line (or approximately vertical inclined transporting line) extending substantially perpendicularly from the area of the roll 10 and a horizontal transporting line extending substantially horizontally to the area of the print head 2. Accordingly, at the junction between the inclined transporting line and the horizontal transporting line, the ink jet paper 1 as being transported will make a turn with an angle of 90 degrees or approximately 90 degrees. And, the transport roller unit 4 is provided at this junction between the inclined transporting line and the horizontal transporting line, and this unit 4 provides functions of applying a transporting force to the ink jet paper 1 (tile force for moving the paper along the transporting lines) and causing the paper 1 to make the turn with an angle of 90 degrees or approximately 90 degrees. That is to say, as may be apparent from FIG. 1, a print sheet portion 1A extending from the roll holder 100 to the drive roller unit 4 and a print sheet portion 1B extending from the drive roller unit 4 to the print head 2 extend normal or substantially normal to each other.

In this embodiment, the transport roller unit 4 consists of a large drive roller 40 disposed on the radially inner side of the turning section and a pair of free clamping rollers 41 opposed to the peripheral surface of the drive roller 40 across the sheet transporting line and spaced apart from each other along the sheet transporting direction. As described hereinbefore, the roll 10 is formed by rolling the elongate ink jet paper 1 with its printing face 1a positioned on the upper side. Hence, the ink jet paper 1 as wound about the drive roller 40 of the transport roller unit 4 is transported, with the printing face 1a thereof being placed in contact with the peripheral surface of the drive roller 40. Therefore, no tensile force will be applied to the printing face 1a, hence, the ink absorbing layer 13, of the ink jet paper 1 which makes a turn with a bending thereof at the area of the transport roller unit 4. Consequently, generation of fissure in the ink absorbing layer 13 is prevented.

On the downstream side of the print head 2 in the sheet transport line, there is provided an assist transport roller unit 5 for applying a transporting force to the ink jet paper 1. Further, in the sheet transport line, between the cutter unit 3 and the tray T, there is provided a discharge roller unit 6 for discharging as a photographic print P onto the tray, the ink jet paper 1 piece having an image formed thereon by the print head 2 and then cut into the print size by the cutter unit 3. The assist transport roller unit 5 and the discharge roller unit 6 are both constructed as a pinching transport type roller unit, each including a driver roller 50, 60 and a free clamping roller 51, 61.

The transport roller unit 4 transports the ink jet paper 1 under an image forming operation by the print head 3, for the purpose of auxiliary scanning. Therefore, a drive shaft 42 mounting the drive roller 40 of the transport roller unit 4 receives a rotational power from an auxiliary scanning motor 43. Further, in order to prevent inadvertent drifting displacement of the ink jet paper 1 during the auxiliary scanning transport by applying a tension along the transporting direction to the ink jet paper 1 fed to the print head 2 by the transport roller unit 4, in cooperation with the transport roller unit 4, the assist transport roller unit 5 assists the transport of the ink jet printer 1 by applying a tension thereto while the paper 1 is receiving an image forming operation by the print head 2. Therefore, it is necessary to synchronize the rotation of the drive roller 40 of the transport roller unit 4 and the rotation of the drive roller 50 of the assist transport unit 5. To this end, in the instant embodiment, a drive sprocket 44 is attached to the drive shaft 42 of the transport roller unit 40 and a driven sprocket 53 is attached to a drive shaft 52 of the drive roller 50, and an endless belt 45 is entrained around the drive sprocket 44 and the driven sprocket 53. With this belt power transmission mechanism, the drive roller 40 of the transport roller unit 4 and the drive roller 50 of the assist transport roller unit 5 are rotated in synchronism with each other. In this, the outer diameter of the driven sprocket 53 of the drive sprocket 44 or the outer diameter of the drive roller 50 or the drive roller 40 is adjusted such that the peripheral speed of the drive roller 50 may be slightly higher than the peripheral speed of the drive roller 40. Further, in order to allow the speed of the ink jet paper 1 passing the ink head 2 to be governed substantially by the transport roller unit 4, through adjustment of the clamping gap between the drive roller 40 and the clamping roller 41, adjustment of the clamping gap between the drive roller 50 and the clamping roller 51 or adjustment of friction coefficients of the peripheral surfaces of the respective rollers, setting is made such that the transporting force provided by the assist transport roller unit 5 may be weaker than the transporting force provided by the transport roller unit 4. In this embodiment, in order to increase the transporting force by the transport roller unit 4, a grid face for increasing friction is formed in the peripheral surface of its drive roller 40.

With the above-described construction in operation for forming an image on the printing face 1a of the ink jet paper l, the transport roller unit 4 transports a leading end of the ink jet paper 1 to the print head area. After this ink jet paper 1 is stopped at a predetermined position over the guide plate 27, the negative pressure box 28 applies a negative pressure to this ink jet paper 1 to cause the paper 1 to be vacuum-stuck to the guide plate 27, thus increasing the flatness of the printing face 1a of the ink jet paper 1. Under this condition, the carriage 23 is moved toward one side along the main scanning direction, and in operative association with this, the print head 2 jets ink<onto the ink jet paper l, whereby an image is formed on the printing face 1a of the ink jet paper 1 by a printing width determined by the specification of the print head 2.

After start of the printing (image forming) operation described above, when the carriage 23 reaches the terminal moving end, the auxiliary scanning motor 43 resumes rotation of the roller 40 of the transport roller unit 4, thereby transporting the ink jet paper 1 by a unit transport amount corresponding to the printing width. Thereafter, the carriage 23 is moved toward the other side (the opposite side) along the main scanning direction, and in operative association with this, the print head 2 jets ink onto the ink jet paper 1, whereby an image is formed on the printing face 1a of the ink jet paper 1 by the printing width. With repetition of these printing operations, a print-sized image is formed eventually on the ink jet paper 1. In this printing process, when the leading end of the ink jet paper 1 is pinched by the assist transport roller unit 5, a tension is applied to the ink jet paper 1, so that the portion of the paper 1 located in the print head area is tensed. This, together with the vacuum-sticking effect provided by the negative pressure box 28, can assure good precision in the stopped condition of the paper 1 as well as greater stability under this stopped condition.

The auxiliary scanning motor 43 described above is used not only for assisting feeding of the ink jet paper 1 to the print head 2, but also for returning a remaining length of the ink jet paper 1 from which the image formed portion has been cut by the cutter unit 3, toward the side of the roll 10 until the leading end of this remaining paper portion reaches a position immediately before the print head 2. For accurate transport of the ink jet paper 1, the motor 43 is feedback-controlled by the PID (Proportional Integral Differential) control technique or the like.

The cutter unit 3 includes a fixed blade 30 fixed to an unillustrated frame, a movable blade 31, a cutter motor 33 and a crank type driving mechanism 32 for driving the movable blade 31 with a reciprocating force converted from the rotational drive force of the cutter motor 33.

In a sheet transporting line extending from the roll 10 through the transport roller unit 4, the print head 2, the auxiliary transport roller unit 5, the cutter unit 3 to the discharge roller unit 6, there are provided a group of guide plates 8, though only some of them are shown in FIG. 3, so as to assist smooth transport of the ink jet paper 1.

The control of ink jetting for the print head 2 and motor control for the main scanning motor 26 and the auxiliary scanning motor 43 are affected based on control signals from a print control unit 7 having a microcomputer as its principal component. This print control unit 7 receives print data for an image forming operation from an unillustrated image processing device.

In the foregoing embodiment, as may be understood from FIG. 1, there is employed the roll 10a comprised of a length of ink jet paper 1 wound with its printing face 1a thereof being on the upper (outer) side and the drive roller 40 of the transport roller unit 4 is disposed so as to switch over the direction of the ink jet paper 1 to the opposite direction to the winding direction of the paper 1 drawn from the roll 10 to direct the paper 1 to the print head 2. As a result, the printing face 1a of the ink jet paper 1 is wound about and placed in contact with the peripheral surface of the drive roller 40. Therefore, in the course of the direction switchover of the ink jet paper 1 at this transport roller unit 4, no tensile force is applied to the printing face la of the ink jet paper 1. In addition, this curving operation for the direction switchover of the ink jet paper 1 at the transport roller unit 4 in this embodiment serves also to eliminate the curling tendency of the roll 10.

Incidentally, in the case of using a roll 10 formed of a length of ink jet paper 1 wound with its printing face 1a on the lower (inner) side, as shown in FIG. 4, the drive roller 40 of the transport roller unit 4 is disposed so as to switch over the direction of the paper 1 in the same direction as the winding direction of the paper 1 drawn from the roll 10 to direct the paper 1 to the print head 2. In this case too, the printing face 1a of the print paper 1 is wound about and placed in contact with the peripheral surface of the drive roller 40. Therefore, in the course of the direction switchover of the ink jet paper 1 at this transport roller unit 4, no tensile force is applied to the printing face 1a of the ink jet paper 1. In this case, however, since the winding direction of the roll 10 and the curving direction at the transport roller unit 4 are the same, this curving operation for the direction switchover of the ink jet paper 1 at the transport roller unit 4 does not serve for elimination of the curling tendency of the roll 10.

in the foregoing embodiment, the two clamping roller 40 are employed as the “opposing portion” for causing the ink jet paper 1 into abutment against the peripheral surface of the drive roller 10. Alternatively, one clamping roller or three or more clamping rollers may be employed. Further, around the respective clamping roller, there is provided a guide plate for preventing projection of the ink jet paper 1. In this respect, it is also possible to construct the opposing portion of such guide plate alone without using any clamping roller-(s). The present invention disposes one roller of a transport roller unit on the inner side of the curving direction switchover portion for the ink jet paper 1 (print sheet), so that a transport force for an auxiliary scanning operation may be applied to the ink jet paper while switching the direction of the print sheet 1 with placing the printing face 1a thereof being placed in contact with the peripheral surface of this roller.

1. A printer with an image forming print head, comprising:
a roll holder holding a roll of print sheet wound with a printing face thereof being on the outer side; and
a transport roller unit for feeding the print sheet drawn out of the roll holder to the print head, the transport roller unit comprising:
a drive roller for moving the print sheet around a peripheral surface thereof for a predetermined distance in a transporting direction, with the printing face thereof being on the inner side, thus applying a transporting force thereto, and
an opposing portion for causing the print sheet into abutment against the peripheral surface of the drive roller.

2. The printer of claim 1, wherein the opposing portion comprises a pair of clamping rollers spaced apart from each other in the transporting direction and disposed in opposition to the peripheral surface of the drive roller.

3. The printer of claim 1, further comprising a first print sheet portion extending from the roller holder to the drive roller and a second print sheet portion extending from the drive roller to the print head; and wherein the first print sheet portion is substantially normal to said second print sheet portion.

4. The printer of claim 3, wherein said roller holder is located vertically upward of said drive roller; and wherein said drive roller and said print head are located in a substantially same level in the horizontal direction.

5. The printer of claim 1, wherein said print head is a line printing type head and wherein the transport roller unit is operable to effect the positioning of the print sheet in an auxiliary scanning direction.

6. The printer of claim 1, further comprising an assist transport roller unit, on the downstream side of the print head in the print sheet transporting direction, for applying a tension to the print sheet passing the print head, and the assist transport roller unit.

7. A printer with an image forming print head, comprising:
a roll holder holding a roll of print sheet wound with a printing face thereof being on the inner side; and
a transport roller unit for feeding the print sheet drawn out of the roll holder to the print head, the transport roller unit comprising:
a drive roller for moving the print sheet around a peripheral surface thereof for a predetermined distance in a transporting direction, with the printing face thereof being on the inner side, thus applying a transporting force thereto, and
an opposing portion for causing the print sheet into abutment against the peripheral surface of the drive roller.

8. The printer of claim 7, wherein the opposing portion comprises a pair of clamping rollers spaced apart from each other in the transporting direction and disposed in opposition to the peripheral surface of the drive roller.

9. The printer of claim 7, further comprising a first print sheet portion extending from the roller holder to the drive roller and a second print sheet portion extending from the drive roller to the print head; and wherein the first print sheet portion is substantially normal to said second print sheet portion.

10. The printer of claim 9, wherein said roller holder is located vertically upward of said drive roller; and wherein said drive roller and said print head are located in a substantially same level in the horizontal direction.

11. The printer of claim 7, wherein said print head is a line printing type head and wherein the transport roller unit is operable to effect the positioning of the print sheet in the auxiliary scanning direction.

12. The printer of claim 7, further comprising an assist transport roller unit, on the downstream side of the print head in the print sheet transporting direction, for applying a tension to the print sheet passing the print head, and the assist transport roller unit having a higher peripheral speed and a smaller transporting force for the print sheet than the transport roller unit.
